(19) United States
(12) Patent Application Publication
(10) Pub. No.: US 2013/0060395 A1
(43) Pub. Date: Mar. 7, 2013

(54) AUTOMATED FIELD PROVISIONING FOR ENERGY MANAGEMENT SYSTEMS

(71) Applicants: Robert Burke, Dallas, TX (US); Prateek Sangal, Frisco, TX (US)

(72) Inventors: Robert Burke, Dallas, TX (US); Prateek Sangal, Frisco, TX (US)

(73) Assignee: HUNT ENERGY IQ, LP, Dallas, TX (US)

(21) Appl. No.: 13/481,036

(22) Filed: May 25, 2012

Related U.S. Application Data
(60) Provisional application No. 61/530,685, filed on Sep. 2, 2011.

(51) Int. Cl. G06F 1/26

(52) U.S. Cl. 700/295

(57) ABSTRACT

A mobile communication device, a computer-implemented method, and a computer program product are provided for automated field provisioning for energy management systems. A meter model is identified based on an electronic image of at least one of a serial number associated with a meter and a quick response code associated with the meter. A location identifier is determined based on a location of the mobile communication device. Information is communicated, via a communication network, to a server associated with an energy management system, wherein the information includes at least one of the meter model and the location identifier.

### CROSS REFERENCE TO RELATED APPLICATIONS

This application is a non-provisional application claiming priority to the U.S. Provisional Patent Application Ser. No. 61/530,685, to Burke, filed on Sep. 2, 2011, which is incorporated herein by reference for all purposes.

### FIELD OF THE PRESENT DISCLOSURE

The invention relates generally to energy management, and more specifically to a system, computer-implemented method, and computer program product for automated field provisioning for energy management systems.

### BACKGROUND

Whenever an energy management solution is deployed, various meters and sub-meters are installed to measure different energy usages of equipment at a site for which the energy usages are to be managed. The meters are then “provisioned” by adding information, such as meter type and site location, to the energy management system. This provisioning is usually a manual and offline process, which requires much offline information. This provisioning process usually requires the information for a batch of sites to be installed in a database for an energy management system before the live data for any of the sites is available via the energy management system. This provisioning process also requires participation from multiple people to provision a single site. For example, a field technician installing a meter at a site may fill out a form for provisioning information, and send this form to a database manager, who enters the provisioning information entered in the form into the database for the energy management system. The provisioning process then includes testing of the meters to insure that the provisioning information was filled out correctly in the field and entered correctly in the database. The whole provisioning process can sometimes take days before the energy management system may depict live data from any of the sites in the field.

### SUMMARY

A system, computer-implemented method, and computer program product are provided for automated field provisioning. The mobile communication device enables a user in the field to accurately identify the model of an installed meter. For example, the mobile communication device includes a scanner or a camera that generates an electronic image of the meter's serial number or quick response code, and the mobile communication device uses the electronic image to specifically identify the meter model. This specific identification of the meter model significantly reduces the possibility of misidentification of meters, such as when a field technician incorrectly records a long serial number. The mobile communication device also enables a user in the field to determine the precise location of the meter based on the precise location of the mobile communication device. For example, the mobile communication device includes a GPS (Global Positioning System) receiver that identifies the precise location of the mobile communication device, and therefore the precise location of the meter that the mobile communication device scanned or photographed. This precise location identifier enables an energy management system to clearly differentiate between multiple meters at the same site. The mobile communication device communicates information via a communication network to an energy management system server. This communicated information can include the information for meter model and the location identifier in a format that is readily accessible by the energy management system's database, thereby assisting the energy management system to quickly and accurately provision the installed meter without having to wait for entire batches of meter information to be processed. This automated provisioning enables the energy management system to start collecting and presenting live data from the provisioned meter as soon as the provisioning for the meter concludes. The automated provision system also will enable the on-site verification of meter connectivity at installation time. This eliminates costly return trips to fix installation problems.

### BRIEF DESCRIPTION OF THE DRAWINGS

Drawings of the preferred embodiments of the present disclosure are attached hereto so that the embodiments of the present disclosure may be better and more fully understood:

FIG. 1 presents a sample system of the present disclosure;

FIG. 2 presents an embodiment of a mobile communication device of the present disclosure;

FIG. 3 presents a sample frame depicted by a user interface of the present disclosure; and

FIG. 4 presents a sample method of the present disclosure.

### DEFINITIONS

As used herein, a mobile communication device may be a mobile phone, a cellular phone, a smart phone, a satellite phone, a navigation system, a personal digital assistant, a portable computer, a laptop computer, a tablet computer, and/or any other device with wireless connectivity. The mobile communication device may communicate over a communication network, such as a cellular telephone network, a satellite network, a Wi-Fi network, another wireless network, and/or the Internet. Many mobile communication devices are either already provided with the capability to communicate via the Bluetooth communication network, the ZigBee communication network, the WiFi communication network, the near field communication (NFC) network, or other similar communication networks. As one skilled in the art will recognize, a mobile communication device may operate on one or more public networks, private networks or combinations of public and private networks.

One skilled in the art will recognize that a location identifier system may operate based on a relative location based system, a latitude/longitude system, another coordinate system, a map segment based system, a cellular or WiFi triangulation system, any other system for identifying a location, and/or any combination of location systems. In one embodiment, the mobile communication device uses a Global Positioning System (GPS) receiver as the location identifier system.

As used herein, equipment refers to one or more energy consuming devices, such as Heating, Ventilation, and Air Conditioning (HVAC) systems, water pumps, compressors, engines, lighting systems, etc. The term equipment may mean a single piece of equipment or a logical grouping of several pieces of equipment. For example, equipment may refer to a group of electrical devices in a single location, such as on a floor of a facility or at a machine bay or on a rig. Similarly, equipment may be grouped by type of device, such as all the HVAC units for a facility.

### DETAILED DESCRIPTION OF SOME EMBODIMENTS

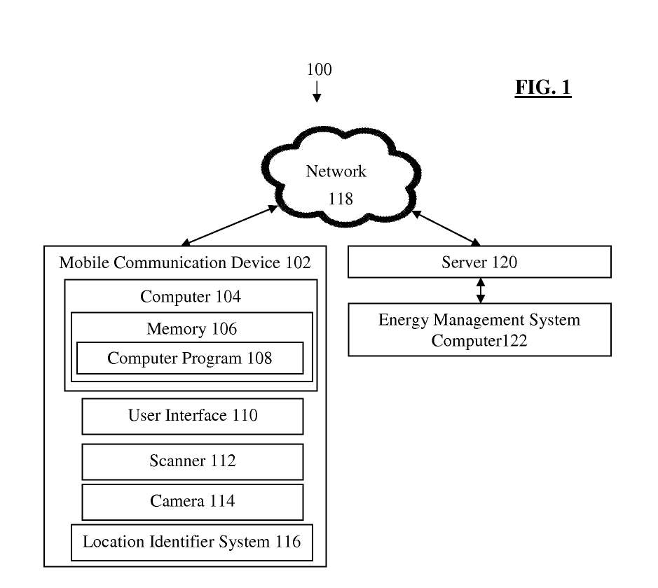

FIG. 1 presents a sample system 100 of the present disclosure, which may also be referred to as an energy management system 100. The system 100 includes a mobile communication device 102, which includes a computer 104, a memory 106, a computer program 108, and a user interface 110. The computer program 108 is stored in the memory 106 and executed by the computer 104 to communicate via the user interface 110 with system users. The computer program 108 may guide users of the mobile communication device 102 through the installation and provisioning steps for meters while using the inputs through the user interface 110. Guiding users through the installation and provisioning steps for meters may significantly reduce the possibility that a user forgets one of the installation or provisioning steps for meters.

The mobile communication device 102 may also include a scanner 112, a camera 114, and a location identifier system 116. The scanner 112 and/or the camera 114 may generate an electronic image of a meter's serial number or quick response code. The mobile communication device 102 may use this electronic image to specifically identify the meter model. The location identifier system 116 determines a location identifier based on a location of the mobile communication device 102, and therefore the location of the meter scanned or photographed by the scanner 112 or the camera 114.

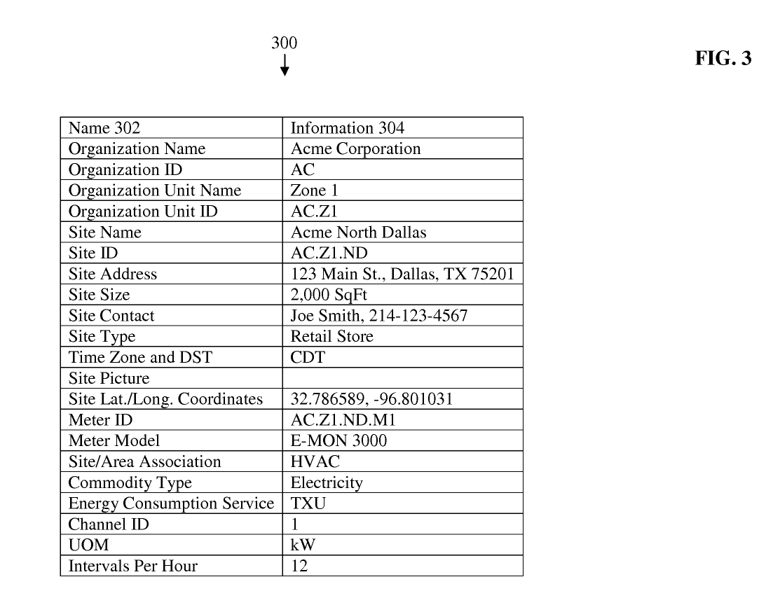

The mobile communication device 102 communicates via a communication network 118 with a server 120, which provides information communicated from the mobile communication device 102 to an energy management system computer 122. An example of the information communicated from the mobile communication device 102 to an energy management system computer 122 is described below in reference to FIG. 3. Although FIG. 1 depicts one of each of the elements 102-122, the system 100 may include any number of each of the elements 102-122.

The mobile communication device 102 enables a user to accurately identify the model of an installed meter. For example, the mobile communication device 102 includes the scanner 112 or the camera 114 to generate an electronic image of the meter's serial number or quick response code. The mobile communication device 102 uses this electronic image to specifically identify the meter model, such as the E-MON 3000 meter model. The mobile communication device 102 may have output, via the user interface 110, a prompt to use the scanner 112 or the camera 114 to generate the electronic image of the serial number and/or the quick response code for the meter. The mobile communication device 102 may use the electronic image that specifically identifies the meter model to also identify a commodity. For example, the computer program 108 may guide a user of the mobile communication device 102 through the provisioning steps for the E-MON 3000 meter model, which the mobile communication device 102 identified, thereby prompting the user to specify the commodity of electricity. This specific identification of the meter model significantly reduces the possibility of misidentification of meters, such as when a technician incorrectly records a long serial number.

The mobile communication device 102 also enables a user in the field to use the location identifier system 116 to determine the precise location of a meter based on the precise location of the mobile communication device 102. For example, the mobile communication device 102 includes the location identifier system 116, which may be a GPS (Global Positioning System) receiver, to identify the precise location of the mobile communication device 102, such as 32.786589 latitude and −96.801031 longitude, which is also the precise location of the meter that the mobile communication device 102 scanned or photographed. This precise location identifier enables the energy management system computer 122 to map multiple meters at the same site.

The mobile communication device 102 communicates information via the communication network 118 to the server 120 for the energy management system computer 122. This communicated information can include the information for the meter model and the location identifier in a format that is readily accessible by the energy management system's database, thereby assisting the energy management system computer 122 to quickly and accurately provision the installed meter without having to wait for entire batches of meter information to be processed. This automated provisioning enables the energy management system 100 to start collecting and presenting live data from the provisioned meter as soon as provisioning for the meter concludes. For example, the energy management system computer 122 depicts live data from the E-MON 3000 meter installed at a Acme North Dallas site prior to provisioning a second meter that is installed at the same Acme North Dallas site and waiting to be provisioned. The automated provision system also will enable the on-site verification of meter connectivity at installation time. This eliminates costly return trips to fix installation problems.

The automated process eliminates the requirement of some pre and post installation provisioning steps. For example, prior art pre-installation steps include the identification of a site location where a meter is to be installed. In contrast, the mobile communication device 102 may use the location identifier system 116 to identify the location of a site after the meter is installed. This provisioning process also reduces the requirement for some provisioning verification steps. For example, a prior art provisioning process may require a database manager to verify that the provisioning information entered by the field technician installing a meter at a site is valid before entering this provisioning information into the database for the energy management system computer 122. In contrast, the mobile communication device 102 may use the scanner 112 or the camera 114 to identify the model of the meter that is installed, significantly reducing the possibility of introducing erroneous information for the meter model into the energy management system computer 122.

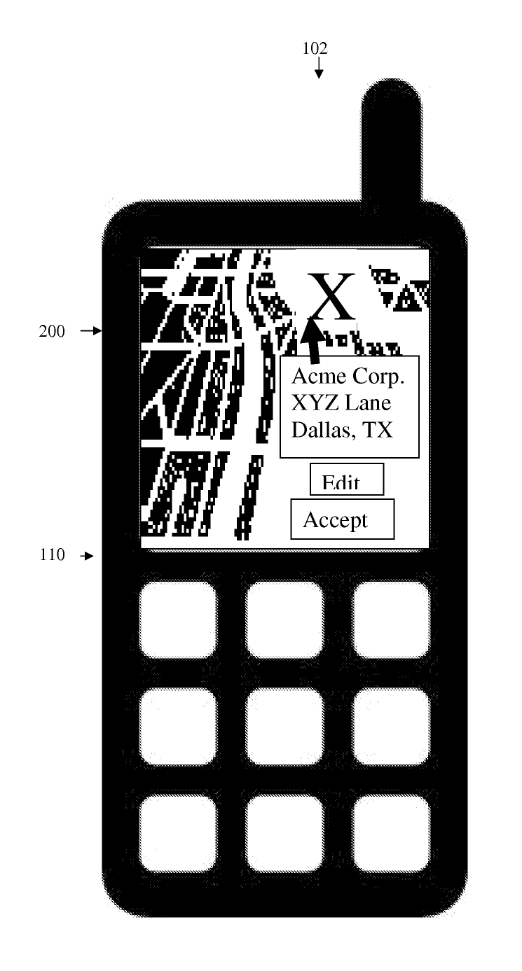

FIG. 2 presents an embodiment of the mobile communication device 102 of the present disclosure. The user interface 110 depicts a frame 200. The frame 200 may be part of a larger display screen that includes fields for users to enter commands to make, edit, and store selections and transform text. The user interface 110 in FIG. 1 may output a display screen that includes the frame 200 in FIG. 2 in response to a search based on search criteria input via the user interface 110 in FIG. 1. For example, a system user may enter search criteria to request to review the frame 200, which corresponds to the selections and text previously entered. In FIG. 2, the frame depicts a map associated with a location identifier determined by the location identifiers system 116. In this example, the frame 200 depicts a street map that includes a location which has been identified as the location of Acme Corporation. The user interface 110 may output a prompt to a user to confirm whether or not the location where the user is currently installing and provisioning a meter is actually Acme Corporation's location identified by the location identifier. Once the location is confirmed, the user interface 110 may also output prompts to a user to select the organization, the site, the site type, the site size, and any other information associated with the meter. Additionally, the user interface 110 may output a request to select a suggested utility provider and a suggested tariff, which may be used in estimating energy costs associated with the meter.

FIG. 3 presents a sample frame 300 presented by the user interface 110 in FIG. 1 of the present disclosure. The frame 300 includes a name 302 column and an information column 304. A user may insure that all of the information in the frame 300 is complete before instructing the mobile communication device 102 to communicate this information via the network 118 to the server 120 for the energy management system computer 122. The site provisioning information to be collected for each site may include: organization name, organization ID, organization unit name, organization unit ID, site name, site ID, site address, site size, site contact, site type, time zone and DST, site latitude and longitude coordinates, meter ID, meter model, site/area association (type and name), commodity type, energy consumption source, channel ID, UOM (units of measure for commodity), and intervals per hour. The site data may also include a site photograph, which may be taken by the camera 114, which may occur after the user interface 110 prompts the user to take the site photograph. Site photographs may assist technicians working at the site in the future in verifying that they are at the correct site.

Because the frames 200-300 in FIG. 2-FIG. 3, respectively, are samples, the frames 200-300 could vary greatly in appearance. For example, the relative sizes and positioning of the columns and rows are not important to the practice of the present disclosure. The frames 200-300 can be depicted by any visual display, but are preferably depicted by a computer screen. The frames 200-300 could also be output as reports and printed or saved in electronic format, such as portable document file (PDF). The frames 200-300 can be part of a personal computer system and/or a network, and operated from system data received locally, by the network, and/or on the Internet. The frames 200-300 may be navigable by a user. Typically, a user can employ a touch screen input or a mouse input device to point-and-click to a location on the frames 200-300 to manage the text on the frames 200-300. Alternately, a user can employ directional indicators, or other input devices such as a keyboard. The text depicted by the frames 200-300 are examples, as the frames 200-300 may include a much greater amount of text.

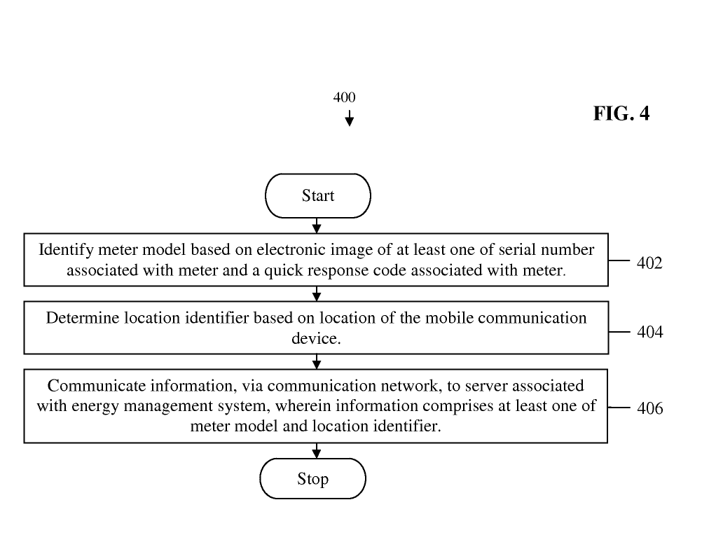

FIG. 4 presents a sample method 400 of the present disclosure. The mobile communication device 102 in FIG. 1 may execute the method 400 to automatically provision meter information for the energy management system computer 122.

In box 402, a meter model is identified based on an electronic image of at least one of a serial number associated with a meter and a quick response code associated with the meter. For example, the scanner identifies the E-MON 3000 meter model based on an electronic image that the camera 114 generated of a quick response code stamped on the meter.

In box 404, a location identifier is determined based on a location of the mobile communication device 102. For example, the location identifier system 116, which is a GPS receiver, determines the location of the mobile communication device 102 as 32.786589 latitude and −96.801031 longitude.

In box 406, information is communicated via the communication network 118 to the server 120 associated with the energy management system computer 122, wherein the information comprises at least one of the meter model and the location identifier. For example, the energy management system computer 122 receives information from the mobile communication device 102 that identifies the E-MON 3000 meter model and the location of the mobile communication device 102 as 32.786589 latitude and −96.801031 longitude.

The method 400 may be repeated as desired. Although this disclosure describes the boxes 402-406 executing in a particular order, the boxes 402-406 may be executed in a different order.

The systems, methods, and computer program products in the embodiments described above are exemplary. Therefore, many details are neither shown nor described. Even though numerous characteristics of the embodiments of the present disclosure have been set forth in the foregoing description, together with details of the structure and function of the present disclosure, the present disclosure is illustrative, such that changes may be made in the detail, especially in matters of shape, size and arrangement of the components within the principles of the present disclosure to the full extent indicated by the broad general meaning of the terms used in the attached claims. The description and drawings of the specific examples above do not point out what an infringement of this patent would be, but are to provide at least one explanation of how to make and use the present disclosure. The limits of the embodiments of the present disclosure and the bounds of the patent protection are measured by and defined in the following claims.

The following are incorporated herein by reference for all purposes: U.S. patent application Ser. No. 13/223,632, filed Sep. 1, 2011, to Burke, entitled “Energy Management Modeling Language;” U.S. patent application entitled “Method and Apparatus for Load Profile Management and Cost Sensitivity Analysis” to Burke, filed concurrently herewith; U.S. patent application Ser. No. 13/155,222, to Burke, entitled “Utility Audit Bill,” filed Jun. 7, 2011; U.S. patent application Ser. No. 13/219,361, to Burke, filed Aug. 26, 2011, entitled “Templatized Reporting Engine;” U.S. patent application entitled “Cost Savings Estimation of Large Scale Deployments using Load Profile Optimization,” to Burke, filed concurrently herewith; and U.S. patent application entitled “Dynamic Tagging to Create Logical Models and Optimize Caching in Energy Management Systems” to Burke, filed concurrently herewith.

1. A mobile communication device for automated field provisioning for an energy management system, the mobile communication device including:
a computer;
a memory;
a user interface; and
a computer program stored in the memory and executable by the computer to:
identify a meter model based on an electronic image of at least one of a serial number associated with a meter and a quick response code associated with the meter;
determine a location identifier based on a location of the mobile communication device;
communicate information, via a communication network, to a server associated with an energy management system, wherein the information comprises at least one of the meter model and the location identifier.

2. A mobile communication device as in claim 1, further comprising outputting, via the user interface, a prompt to generate the electronic image of at least one of the serial number associated with the meter and the quick response code associated with the meter.

3. A mobile communication device as in claim 1, further comprising at least one of a scanner and a camera to generate the electronic image of at least one of the serial number associated with the meter and the quick response code associated with the meter.

4. A mobile communication device as in claim 1, wherein identifying the meter model comprises identifying a commodity.

5. A mobile communication device as in claim 4, wherein the information further comprises the commodity.

6. A mobile communication device as in claim 1, further comprising outputting, via the user interface, a request to select at least one of an organization associated with the meter and a site associated with the meter.

7. A mobile communication device as in claim 6, wherein the information further comprises the organization associated with the meter and the site associated with the meter.

8. A mobile communication device as in claim 1, further comprising outputting, via the user interface, a request to select at least one of a site type associated with the meter and a site size associated with the meter.

9. A mobile communication device as in claim 8, wherein the information further comprises the site type associated with the meter and the site size associated with the meter.

10. A mobile communication device as in claim 1, further comprising outputting, via the user interface, an option to confirm a site address based on the location identifier.

11. A mobile communication device as in claim 1, further comprising outputting, via the user interface, a request to generate a site photograph.

12. A mobile communication device as in claim 11, wherein the information further comprises the site photograph.

13. A mobile communication device as in claim 1, further comprising a camera to generate a site photograph.

14. A mobile communication device as in claim 1, further comprising outputting, via the user interface, a request to select at least one of a suggested utility provider and a suggested tariff, wherein at least one of the suggested utility provider and the suggested tariff is based on the location identifier.

15. A mobile communication device as in claim 14, wherein the information further comprises the selected utility provider and the selected tariff.

16. A mobile communication device as in claim 1, wherein the energy management system depicts live data from the meter prior to provisioning a second meter associated with a site associated with the location identifier.

17. A computer-implemented method for automated field provisioning for energy management systems, the method including the steps of:
identifying, by a computer program stored in a memory and executed by a computer, a meter model based on an electronic image of at least one of a serial number associated with a meter and a quick response code associated with the meter;
determining, by the computer program, a location identifier based on a location of a mobile communication device associated with the computer;
communicating information, by the computer program via a communication network, to a server associated with an energy management system, wherein the information includes at least one of the meter model and the location identifier.

18. A computer-implemented method as in claim 17, wherein determining the location identifier is based on at least one of a relative location based system, a latitude/longitude system, a map segment based system, a cellular triangulation system, a WiFi triangulation system, and a Global Positioning System (GPS).

19. A computer program product for automated field provisioning for energy management systems, the computer program product including:
a computer readable storage medium storing computer executable program code that, when executed by a processor, causes the computer executable program code to perform a method including the steps of:
identifying a meter model based on an electronic image of at least one of a serial number associated with a meter and a quick response code associated with the meter;
determining a location identifier based on a location of a mobile communication device associated with the processor;
communicating information, via a communication network, to a server associated with an energy management system, wherein the information includes at least one of the meter model and the location identifier.

20. A computer program product as in claim 19, wherein the communication network, comprises at least one of a cellular telephone network, a satellite network, a Wi-Fi network, an Internet, a Bluetooth communication network, a ZigBee communication network, and a near field communication (NFC) network.
